(19) United States
(12) Patent Application Publication
(10) Pub. No.: US 2026/0132677 A1
(43) Pub. Date: May 14, 2026

(54) Convertible Folding Ladder with Safety Lights and Base

(71) Applicant: Stephen Pak, Birmingham, AL (US)

(72) Inventor: Stephen Pak, Birmingham, AL (US)

(21) Appl. No.: 19/096,229

(22) Filed: Mar. 31, 2025

Related U.S. Application Data
(60) Provisional application No. 63/718,235, filed on Nov. 8, 2024.

(51) Int. Cl. E06C 1/18; A47B 85/06; E04H 15/46; E06C 1/00; E06C 1/38; E06C 7/00; E06C 7/42

(52) U.S. Cl. CPC E06C 1/18; A47B 85/06; E04H 15/46; E06C 1/005; E06C 1/38; E06C 7/003; E06C 7/42

(57) ABSTRACT

The present invention relates to a fully adjustable A-frame ladder designed for versatile use in various contexts. The ladder, constructed from materials such as aluminum or carbon fiber, features telescopic legs with six points of adjustment, allowing for customizable height and angle configurations. A ground-level base provides enhanced stability and can double as a tabletop. The ladder includes integrated LED lights for use in low-light conditions and can be collapsed for compact storage and easy transport. Additionally, the ladder's design allows it to be used as a picnic table or as support for tents, demonstrating its multifunctional capabilities.

The current application claims a priority to the U.S. Provisional Patent application Ser. No. 63/718,235 filed on Nov. 8, 2024.

### FIELD OF THE INVENTION

The present invention relates generally to ladders. More specifically, the present invention is a folding stepladder that features integrated lighting and a safety base.

### BACKGROUND OF THE INVENTION

Stepladders are used by many homeowners, do-it-yourselfers, construction workers, and various tradesmen for a variety of tasks. Presently, the use of existing stepladders imposes a safety risk upon its users due to instability and an assistant is often used to help stabilize the stepladder.

The present invention addresses these safety concerns by utilizing a special base at ground level to keep the ladder immobilized and safe, which also allows the user to operate the device with confidence. Additional benefits include LED lights to increase visibility and safety in working conditions as well as a lightweight, collapsible design to aid in storage and transportation. The present invention can also be set in a variety of positions, which eliminate the need for multiple ladders. These configurations are so diverse that the present invention can also be used as a workstation or picnic table.

### BRIEF DESCRIPTION OF THE DRAWINGS

FIG. 1 shows the present invention in its standard ladder form.

FIG. 2 shows the present invention converted to a table.

FIG. 3 shows the present invention folded for storage.

FIG. 4 shows the present invention stored with a hanger.

FIG. 5 shows the present invention with the ladder folded flat into the base.

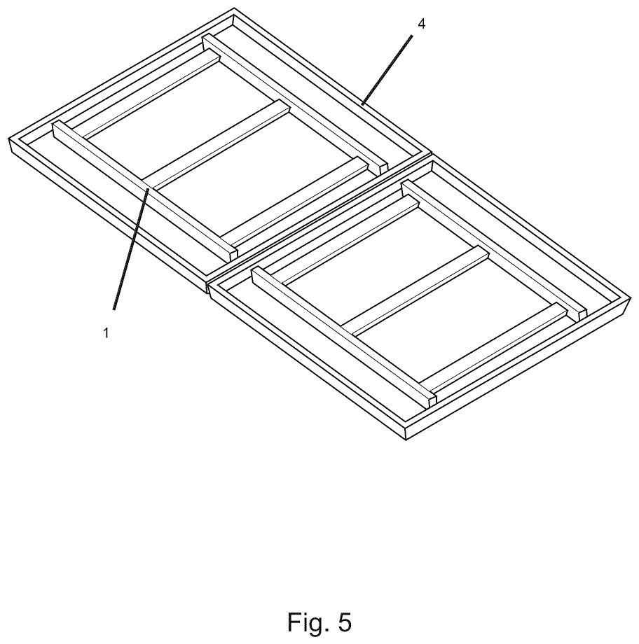

FIG. 6 shows the present invention used in a tailgating setting, where the ladder serves to hold up a tarp and as a set of tables.

FIG. 7 shows the present invention holding up a tarp or tent.

FIG. 8 shows the present invention in a shorter and wider form compared to FIG. 1.

FIG. 9 shows the present invention holding up a tarp or tent larger than the one in FIG. 7.

### DETAILED DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

The present disclosure includes many aspects and features. Moreover, while many aspects and features relate to, and are described in the context of a convertible folding ladder with safety lights and base, embodiments of the present disclosure are not limited to use only in this context.

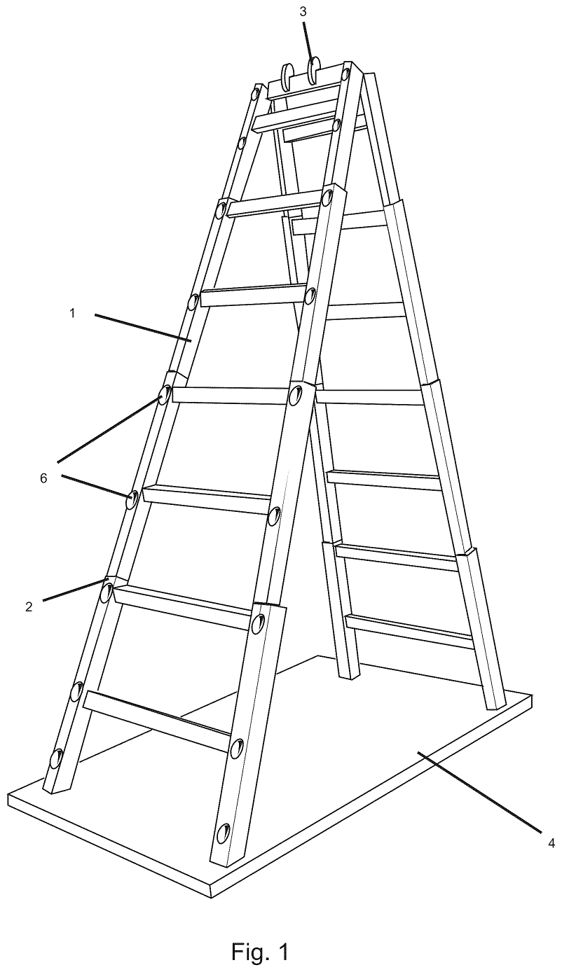

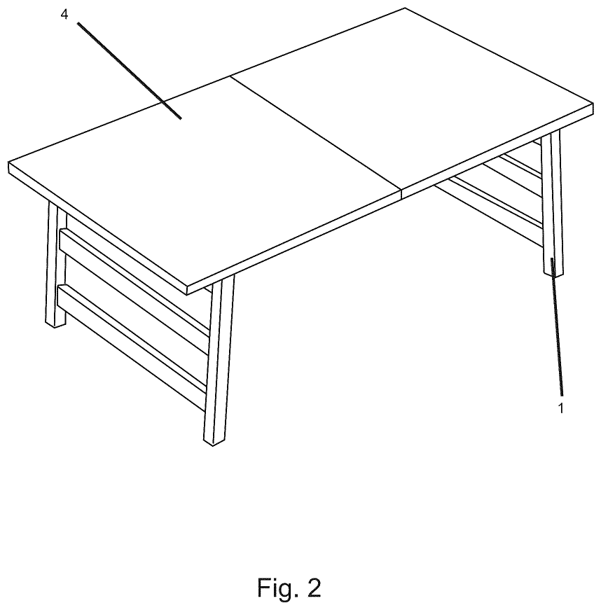

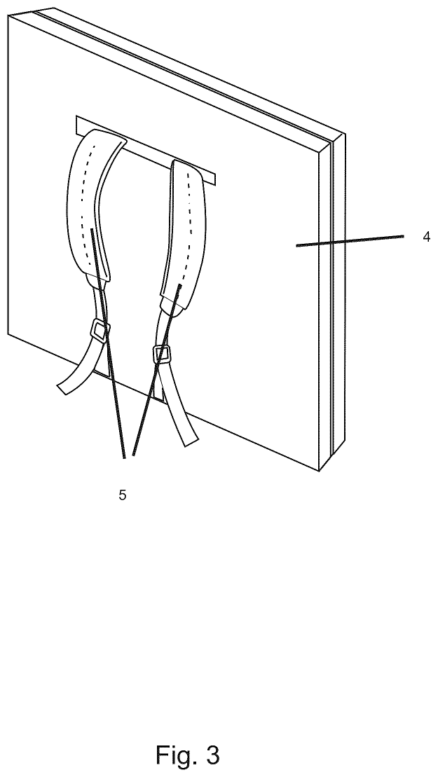

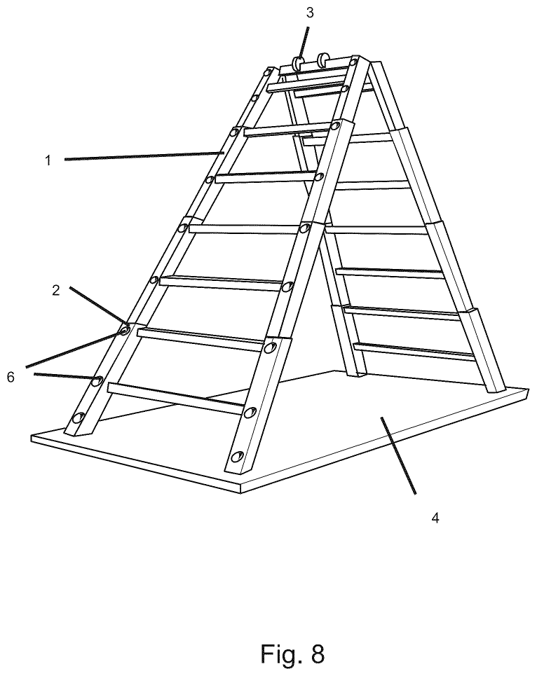

The present invention comprises a fully adjustable A-frame ladder (1). In the preferred embodiment, the ladder (1) is made from aluminum or carbon fiber and measures approximately 10 feet tall, 6 feet long, and 2 feet wide. Other materials and dimensions are possible and considered within the scope of the present invention. The legs are telescopic with at least one point of adjustment (2), allowing the user to select the overall size needed and create different angles. FIG. 1 shows a taller orientation of the ladder, with a sharper angle. FIG. 8 shows the ladder in a shorter orientation with a wider angle. It can be secured at the desired size along with a top locking mechanism (3). The present invention further comprises a base (4) that is set at ground level, as shown in FIG. 1. The bottom of all four ladder legs lock into this base (4) to provide the best possible support and stability while working, without requiring an assist to hold the ladder (1) steady when working in elevated positions. The base (4) is multi-purpose, serving to stabilize the ladder (1), or act as a tabletop, as shown in FIG. 2. When folded, the present invention may have back pack straps (5) for ease of transport, as shown in FIG. 3.

The present invention further comprises a series of LED lights (6), preferably equally spaced along all four legs. The battery powered lights (6) can be switched on when working in darkness or limited lighting conditions.

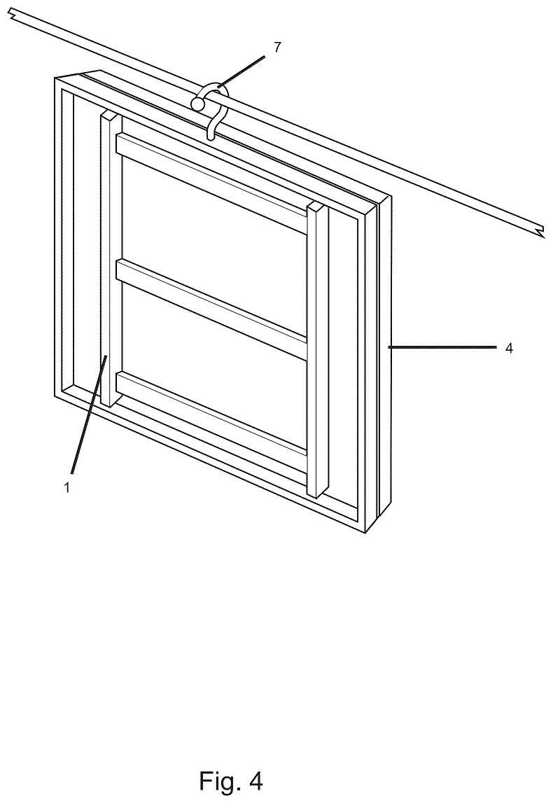

The present invention is collapsible, allowing it to be reduced to a compact storage state, including being suspended from a hook (7) inside a closet for added convenience as shown in FIG. 4. The present invention is adjustable such that the base (4) gets repositioned on top of the legs being directed downward at 90 degrees at the ends, allowing it to serve as a picnic table.

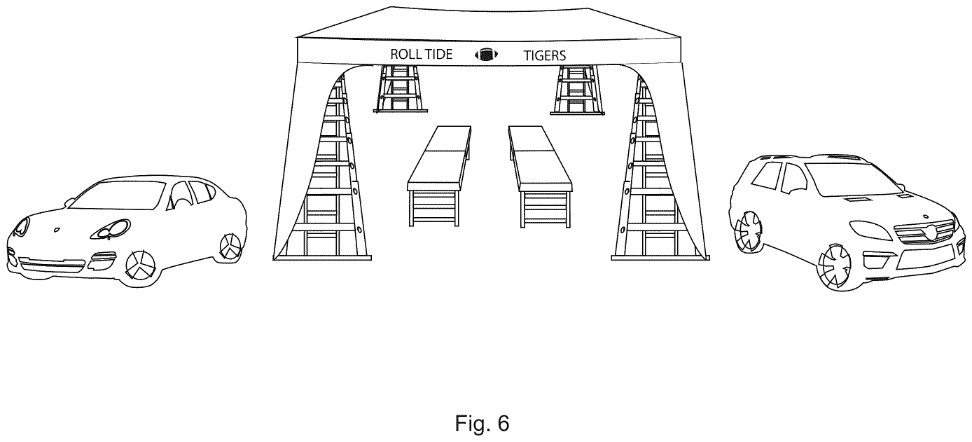

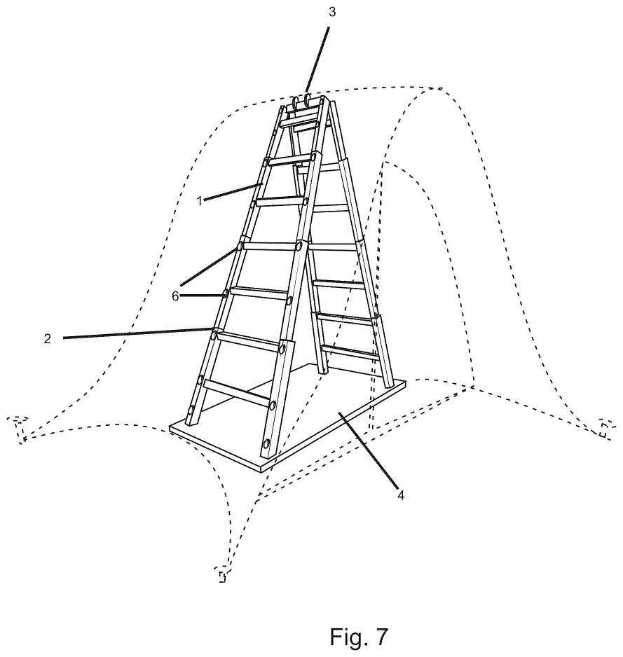

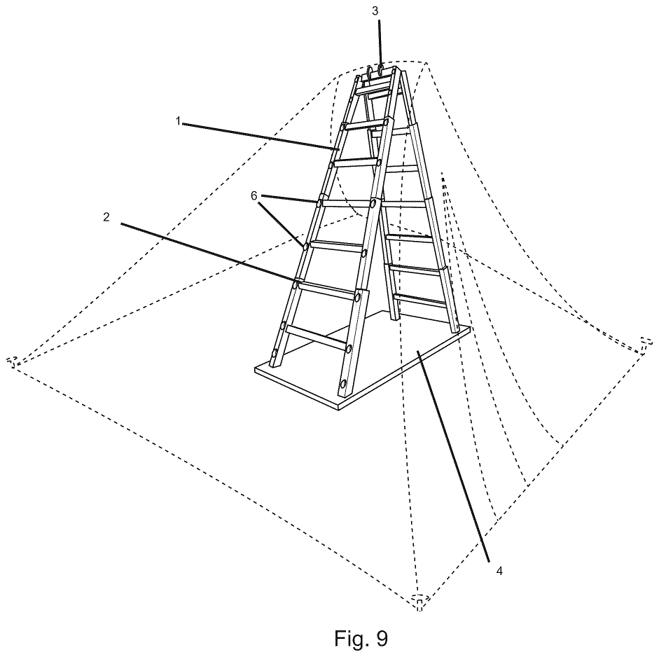

The top of the ladder (1) further comprises anchor points to which a tarp or tent may be attached, as shown in FIG. 7 and FIG. 9. Multiple ladders may be used to hold up even larger tents, as shown in FIG. 6. The tailgating scenario depicted in FIG. 6 shows the diverse utility of the present invention. Four ladders are holding up the corners of the tent, while two more ladders are serving as tables. Additionally, if it's nighttime, the LED lights (6) of the present invention can light the tent's interior. The present invention's convertibility and adaptability allow for use in a variety of contexts not limited to standard ladder uses.

Although the invention has been explained in relation to its preferred embodiment, it is to be understood that many other possible modifications and variations can be made without departing from the spirit and scope of the invention.

What is claimed is:

1. An adjustable A-frame ladder, comprising,
telescopic legs with at least one point of adjustment;
a top locking mechanism to secure the legs at a desired size and angle; and
a ground-level base to which the legs are lockable, providing stability.

2. The ladder of claim 1, further comprising,
a series of LED lights equally spaced along the legs;
a battery power source for the LED lights; and
a switch to control the LED lights.

3. The ladder of claim 1, wherein the base and legs fold into each other at varying angles for different configurations.

4. The ladder of claim 1, wherein the ladder is collapsible for compact storage, and the base further comprises backpack straps and a hanging hook to facilitate transportation and storage.

5. The ladder of claim 1, wherein the base can be repositioned on top of the legs.

6. The ladder of claim 1, further comprising anchor points at the top of the ladder for attaching a tarp or tent.

7. The ladder of claim 6, wherein multiple ladders can be used to support larger tents.
